(19) United States
(12) Patent Application Publication
(10) Pub. No.: US 2006/0057391 A1
(43) Pub. Date: Mar. 16, 2006

(54) Structure comprising at least one polyethylene layer and at least one layer of barrier polymer

(76) Inventors: Anthony Bonnet, Beaumont Le Roger (FR); Fabrice Chopinez, Evreux (FR); Gaelle Bellet, Evreux (FR); David Silagy, Evreux (FR)

Correspondence Address: Thomas F. Roland, Esq.;Arkema Inc., 2000 Market St., Philadelphia, PA, 19103, US

(21) Appl. No.: 11/226,137

(22) Filed: Sep. 14, 2005

Related U.S. Application Data
(60) Provisional application No. 60/632,417, filed on Dec. 2, 2004.

(30) Foreign Application Priority Data
Sep. 15, 2004 (FR) 04.09755

(51) Int. Cl. B32B 27/08; B32B 27/32

(52) U.S. Cl. 428/421; 428/523; 428/516; 428/521

(57) ABSTRACT

The present invention relates to a structure successively comprising: a layer of barrier polymer, a tie layer comprising, the total being 100%: 1 to 80% of at least one polyethylene carrying epoxy functional groups, 99 to 20% of at least one viscous polymer compatible with the polyethylene carrying epoxy functional groups, a polyethylene layer, and optionally another tie layer and a layer of barrier polymer, the layers adhering in their respective contact zones. This structure is of use in preparing devices for the storage or transfer of fluids, in particular in motor vehicles. The invention also relates to these devices. These devices can be pipes, tanks, bottles or containers in which the layer of barrier polymer is in contact with the stored or transported fluid. These structures can comprise other layers composed of other materials.

This application claims benefit, under U.S.C. §119(a) of French National Application Number 04.09755, filed Sep. 15, 2004; and also claims benefit, under U.S.C. § 119(e) of U.S. provisional application 60/632,417, filed Dec. 2, 2004.

### FIELD OF THE INVENTION

The present invention relates to a structure comprising at least one polyethylene layer and at least one layer of barrier polymer. These structures are of use, for example, in the manufacture of pipes, tanks, bottles and containers in which the layer of barrier polymer is in contact with the stored or transported fluid. The preceding objects can be manufactured by the usual techniques for the conversion of thermoplastic materials, such as coextrusion or coextrusion blow-moulding. The term “barrier” means, for example, that this layer does not allow the petrol used in motor vehicles to pass through or allows only a very small amount to pass through.

### BACKGROUND OF THE INVENTION

Polyethylene has barrier properties with regard to petrol but these properties are unsatisfactory for many uses. It is necessary for the structure to also comprise a layer of barrier polymer. However, the majority of barrier polymers are incompatible with polyethylene. Thus, it is necessary to position a tie layer between the polyethylene layer and the layer of barrier polymer. Polyethylenes which carry epoxy functional groups, such as, for example, glycidyl (meth)acrylate, are possible ties between polyethylene and a barrier material, such as PPS or a polyester. The abbreviation “PPS” denotes poly(phenylene sulphide). However, it is sometimes difficult to coextrude these materials and the peel strength is sometimes too low. It has now been found that a blend of a polyethylene carrying epoxy functional groups with a viscous polymer which is compatible with it is a very good tie.

### SUMMARY OF THE INVENTION

The present invention relates to a structure successively comprising:
a layer of barrier polymer,
a tie layer comprising, the total being 100%:
   1 to 80% of at least one polyethylene carrying epoxy functional groups,
   99 to 20% of at least one viscous polymer compatible with the polyethylene carrying epoxy functional groups,
a polyethylene layer,
   the layers adhering in their respective contact zones.

According to an alternative form, the present invention relates to a structure successively comprising:
a layer of barrier polymer,
a tie layer comprising, the total being 100%:
   1 to 80% of at least one polyethylene carrying epoxy functional groups,
   99 to 20% of at least one viscous polymer compatible with the polyethylene carrying epoxy functional groups,
a polyethylene layer,
a tie layer comprising, the total being 100%:
   1 to 80% of at least one polyethylene carrying epoxy functional groups,
   99 to 20% of at least one viscous polymer compatible with the polyethylene carrying epoxy functional groups,
a layer of barrier polymer,
   the layers adhering in their respective contact zones.

According to a preferred form, the viscous polymer compatible with the polyethylene carrying epoxy functional groups is a polyethylene.

According to one alternative form of the invention, if the viscous polymer compatible with the polyethylene carrying epoxy functional groups is a polyethylene and if the blend of this viscous polyethylene compatible with the polyethylene carrying epoxy functional groups has sufficient mechanical strength to be able to be coextruded with the barrier polymer, then it is possible to dispense with the polyethylene layer which is adjacent to the tie layer, that is to say that, in this alternative form, the structure successively comprises:

either:

a layer of barrier polymer,
a tie layer comprising, the total being 100%:
   1 to 80% of at least one polyethylene carrying epoxy functional groups,
   99 to 20% of at least one viscous polyethylene compatible with the polyethylene carrying epoxy functional groups,
      the layers adhering in their respective contact zones.
      or:
a layer of barrier polymer,
a tie layer comprising, the total being 100%:
   1 to 80% of at least one polyethylene carrying epoxy functional groups,
   99 to 20% of at least one viscous polyethylene compatible with the polyethylene carrying epoxy functional groups,
a layer of barrier polymer,
   the layers adhering in their respective contact zones.

This structure is of use in preparing devices for the storage or transfer of fluids, in particular in motor vehicles. The invention also relates to these devices. These devices can be pipes, tanks, bottles or containers in which the layer of barrier polymer is in contact with the stored or transported fluid. These structures can comprise other layers composed of other materials.

### DETAILED DESCRIPTION OF THE INVENTION

As regards the barrier polymer, mention may be made, by way of example, of PVDF. This term is used to denote PVDFs which are vinylidene fluoride (VDF) homopolymers and vinylidene fluoride (VDF) copolymers preferably comprising at least 50% by weight of VDF and at least one other monomer which is copolymerizable with VDF. The comonomer is advantageously fluorinated. It can be chosen, for example, from vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl ether)s, such as perfluoro(methyl vinyl ether) (PMVE), perfluoro(ethyl vinyl ether) (PEVE) and perfluoro(propyl vinyl ether) (PPVE); perfluoro(1,3-dioxole); and perfluoro(2,2-dimethyl-1,3-dioxole) (PDD). The optional comonomer is preferably chosen from chlorotrifluoroethylene (CTFE), hexafluoropropylene (HFP), trifluoroethylene (VF3) and tetrafluoroethylene (TFE).

Preferably, the PVDF comprises, by weight, at least 50% of VDF, more preferably at least 75% and better still at least 85%. The comonomer is advantageously HFP.

Mention may also be made of polyesters, such as PBT (poly(butylene terephthalate)), PEN (poly(ethylene naphthalate)) and PBN (poly(butylene naphthalate)).

Mention may also be made of polyketones, poly(dimethyl ketene)s and PPS. Poly(dimethyl ketene)s are disclosed in patent application U.S. 2004121099, and patents U.S. Pat. Nos. 6,528,135, 6,793,995 and WO 04/044030.

The barrier polymer is not PVC nor polypropylene.

The barrier polymer can be functionalized in all or part, that is to say that the layer of barrier polymer comprises, the total being 100%, from 1 to 100% of functionalized barrier polymer and from 99 to 0% of barrier polymer. Advantageously, the layer of barrier polymer comprises, the total being 100%, from 1 to 40% of functionalized barrier polymer and from 99 to 60% of barrier polymer. Preferably, the layer of barrier polymer comprises, the total being 100%, from 15 to 40% of functionalized barrier polymer and from 85 to 60% of barrier polymer.

According to another form of the invention, the layer of barrier polymer can be composed of two layers, one comprising a blend, the total being 100%, of 1 to 100% of functionalized barrier polymer and from 99 to 0% of barrier polymer, this layer being positioned against the tie layer, and the other composed of the barrier polymer.

According to an advantageous form of the invention, the layer of barrier polymer is composed of two layers, one comprising a blend, the total being 100%, of 1 to 40% of functionalized barrier polymer and from 99 to 60% of barrier polymer, this layer being positioned against the tie layer, and the other composed of the barrier polymer.

According to a preferred form of the invention, the layer of barrier polymer is composed of two layers, one comprising a blend, the total being 100%, of 15 to 40% of functionalized barrier polymer and from 85 to 60% of barrier polymer, this layer being positioned against the tie layer, and the other composed of the barrier polymer.

A functionalized barrier polymer is a barrier polymer comprising at least one polar groups (such as an epoxy group, an anhydride group, an acid group, a salt from an acid group) linked to the chains of the barrier polymer. As way of example, it can be mentioned a PVDF grafted by an unsaturated monomer or a copolymer of VDF and at least one unsaturated monomer (possibly along with another comonomer, in which case the polymer is a terpolymer).

The PVDF grafted by an unsaturated monomer can be manufactured according to a grafting process in which:
a) the fluorinated polymer is melt blended with the unsaturated monomer,
b) the blend obtained in a) is formed into films, sheets, granules or powders,
c) the products from stage b) are subjected, in the absence of air, to photon irradiation (□) or electron irradiation (□) under a dose of between 1 and 15 Mrad,
d) the product obtained in c) is optionally treated to remove all or part of the unsaturated monomer which has not been grafted to the fluorinated polymer.

As regards the unsaturated grafting monomer, mention may be made, by way of examples, of carboxylic acids and their derivatives, such as acid anhydrides, acid chlorides, isocyanates, oxazolines, epoxides, amines or hydroxides. Preferably, the unsaturated monomer contains only one C═C double bond, ao as to avoid any cross-linking of the PVDF (leading to an increase of the viscosity and potential difficulties in extruding the material).

Examples of unsaturated carboxylic acids are those having 2 to 20 carbon atoms, such as acrylic acid, methacrylic acid, maleic acid, fumaric acid and itaconic acid. The functional derivatives of these acids comprise, for example, the anhydrides, the ester derivatives, the amide derivatives, the imide derivatives and the metal salts (such as the alkali metal salts) of the unsaturated carboxylic acids. Mention may also be made of undecylenic acid.

Unsaturated dicarboxylic acids having 4 to 10 carbon atoms and their functional derivatives, particularly their anhydrides, are particularly preferred grafting monomers. Maleic anhydride is preferred as it shows little homopolymerization and gives good adhesion values. The grafting of maleic anhydride is preferred as the copolymerization of VDF and maleic anhydride is not easily carried out with the current dispersed industrial processes (emulsion or suspension).

Stage a) is carried out in any blending device, such as extruders or mixers, used in the thermoplastics industry.

As regards the proportions of the fluorinated polymer and of the unsaturated monomer, the proportion of fluorinated polymer is advantageously, by weight, from 90 to 99.9% for respectively from 0.1 to 10% of unsaturated monomer. Preferably, the proportion of fluorinated polymer is from 95 to 99.9% for respectively from 0.1 to 5% of unsaturated monomer.

On conclusion of stage a), it is found that the blend of the fluorinated polymer and of the unsaturated monomer has lost approximately from 10 to 50% of the unsaturated monomer which had been introduced at the beginning of stage a). This proportion depends on the volatility and on the nature of the unsaturated monomer. In fact, the monomer has been degassed in the extruder or the mixer and it is recovered in the vent lines.

As regards stage c), the products recovered on conclusion of stage b) are advantageously packed in polyethylene bags, the air is driven off and then they are closed. With regard to the irradiation method, use may be made, without distinction, of electron irradiation, better known under the name of β irradiation, and photon irradiation, better known under the name of γ irradiation. Advantageously, the dose is between 2 and 6 Mrad and preferably between 3 and 5 Mrad. Preferably, the source of irradiation is 60 cobalt bomb.

The grafting process takes place “cold” typically at temperatures below 100° C., or even below 50° C., so that the PVDF/unsaturated monomer compound is not in the melt state, as in the case of a conventional grafting process carried out in an extruder. One essential difference is therefore that, in the case of a semicrystalline (as is the case with PVDF), the grafting takes place in the amorphous phase and not in the crystalline phase, whereas homogeneous grafting takes place in the case of melt grafting in an extruder. The unsaturated monomer is therefore not distributed along the PVDF chains in the same way in the case of radiation grafting as in the case of grafting carried out in an extruder.

As regards stage d), the ungrafted monomer can be removed by any means. The proportion of grafted monomer with respect to the monomer present at the beginning of stage c), is between 50 and 100%. Washing can be carried out with solvents which are inert with respect to the fluorinated polymer and the grafted functional groups. For example, when maleic anhydride is grafted, washing can be carried out with chlorobenzene. It is also possible more simply to degas by placing the product recovered in stage c) under vacuum.

As regards the tie layer and first the polyethylene carrying epoxy functional groups, this can be a polyethylene to which epoxy functional groups have been grafted or a copolymer of ethylene and of an unsaturated epoxide.

As regards the copolymers of ethylene and of an unsaturated epoxide, mention may be made, for example, of copolymers of ethylene, of an alkyl (meth)acrylate and of an unsaturated epoxide or copolymers of ethylene, of a saturated carboxylic acid vinyl ester and of an unsaturated epoxide. These copolymers are prepared by a high pressure copolymerization process (P higher than 1000 bar). The amount of epoxide can be up to 15% by weight of the copolymer and the amount of ethylene at least 50% by weight. Advantageously, the proportion of epoxide is between 2 and 12% by weight. Advantageously, the proportion of alkyl (meth)acrylate is between 0 and 40% and preferably between 5 and 35% by weight.

Advantageously, it is a copolymer of ethylene, of an alkyl (meth)acrylate and of an unsaturated epoxide. Preferably, the alkyl (meth)acrylate is such that the alkyl has 1 to 10 carbon atoms.

The examples of alkyl acrylate or methacrylate which can be used are in particular methyl methacrylate, methyl acrylate, ethyl acrylate, n-butyl acrylate, isobutyl acrylate or 2-ethylhexyl acrylate. Preferably, it is ethyl acrylate, butyl acrylate, methyl acrylate or 2-ethylhexyl acrylate.

The MFI (melt flow index) can be, for example, between 0.1 and 50 (g/10 min at 190° C. under 2.16 kg).

Examples of unsaturated epoxides which can be used are in particular:
aliphatic glycidyl esters and ethers, such as allyl glycidyl ether, vinyl glycidyl ether, glycidyl maleate, glycidyl itaconate, glycidyl acrylate and glycidyl methacrylate, and
alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 2-methyl-5-norbornene-2-carboxylate and diglycidyl endo-cis-bicyclo[2.2.1]hept-5-ene-2,3-dicarboxylate.

Glycidyl methacrylate is preferred as it is easily copolymerized with ethylene and shows a good chemical reactivity.

As regards the tie layer and now the viscous polymer compatible with the polyethylene carrying epoxy functional groups, mention may be made of hydrogenated SBS block copolymers, such as, for example, SEBSs, EPRs, EPDMs and polyethylene. This polyethylene can be LDPE, LLDPE, HDPE and any polyethylene manufactured by any process, whether in the gas phase, in bulk or in solution and whether by Ziegler catalysis, by radical initiation or by metallocene catalysis (or monosite catalysis). Advantageously, the MFI (Melt Flow Index) of this compatible viscous polymer is between 0.1 and 1 g/10 min at 190° C. and under 2.16 kg and preferably between 0.15 and 0.5. It is advantageously an HDPE.

With regard to the proportions of the constituants of the tie layer, they are:
1 to 80% of the polyethylene carrying epoxy functional groups,
99 to 20% of the viscous polymer compatible with the polyethylene carrying epoxy functional groups,
   advantageously:
10 to 50% of the polyethylene carrying epoxy functional groups,
90 to 50% of the viscous polymer compatible with the polyethylene carrying epoxy functional groups,
   and preferably:
10 to 40% of the polyethylene carrying epoxy functional groups,
90 to 60% of the viscous polymer compatible with the polyethylene carrying epoxy functional groups.

Advantageously, the MFI of the tie is between 0.15 and 1 g/10 minutes (measured at 190° C. under 2.16 kg).

As regards the polyethylene layer, this polyethylene can be LDPE, LLDPE, HDPE and any polyethylene manufactured by any process, whether in the gas phase, in bulk or in solution and whether by Ziegler catalysis, by radical initiation or by metallocene catalysis (or monosite catalysis). It is advantageously HDPE as HDPE has excellent tensile and impact properties at temperatures as low as −50° C.

The structures of the invention can comprise other layers.

The structure can have any thickness. The thickness is, for example, between 100 μm and 25 mm.

As regards the alternative form in which the viscous polymer compatible with the polyethylene carrying epoxy functional groups is a polyethylene and in which the blend of this viscous polyethylene compatible with the polyethylene carrying epoxy functional groups has sufficient mechanical strength to be able to be coextruded with the barrier polymer, it has been seen that it is possible to dispense with the polyethylene layer which is adjacent to the tie layer. Everything which has been described above, and in particular the composition of the tie, the composition of the barrier layer (or layers) and the nature of the products, is valid in this alternative form, except, of course, that which is specific to this alternative form. In fact, in this alternative form, the viscous polymer compatible with the polyethylene carrying epoxy functional groups is advantageously HDPE.

### EXAMPLES

The following polymers were used:

Kynar® 720: PVDF homopolymer from Atofina and with an MVI (Melt Volume Index) of 10 cm³/10 min (230° C., 5 kg).

PVDF-1: PVDF homopolymer (Kynar® 720) grafted by maleic anhydride, grafted at 9000 ppm, with an MVI (Melt Volume Index) of 7 cm³/10 min (measured at 230° C. under 5 kg). The grafting was carried out through the irradiation with a cobalt 60 bomb of a mixture of Kynar 720 and maleic anhydride that was obtained with a twi-screw extruder at 230° C., 150 rpm with a mass flow-rate of 10 kg/h. The irradiation was carried out under 3 Mrad for 17 hours. After the irradiation step, the product is placed overnight under vacuum at 130° C. to get free of the ungrafted maleic anhydride. The content of the grafted maleic anhydride (9000 ppm) was determined by infrared spectroscopy.

Lotader® 8840: copolymer of ethylene and of glycidyl methacrylate from Atofina and with an MVI (Melt Volume Index) of 5 cm³/10 min (190° C., 2.16 kg). It comprises 92% of ethylene and 8% of glycidyl methacrylate by weight.

Finathene® 3802 HDPE: denotes a high density polyethylene from Atofina with an MFI of 0.2 g/10 minutes under 2.16 kg at 190° C. Its density is 0.938.

Fortron® 0214: denotes a poly(phenylene sulphide) from Ticona with an MFI of 57 at 315° C., under 5 kg. Its density is 1.35.

### Example 1

### According to the Invention

The preparation is carried out, on an extruder of McNeil type, of a three layer structure composed, from the inside outwards, of a layer with a thickness of 300 μm of a blend of 30% of PVDF-1 and of 70% of Kynar® 720, coextruded over a layer with a thickness of 100 μm of a blend obtained by dry blending, at the foot of the machine, 50% by weight of Lotader® 8840 and 50% of Finathene® 3802 HDPE. This layer is itself coextruded over a layer with a thickness of 2.6 mm of Finathene® 3802. The final structure exhibits an external diameter of 32 mm and a thickness of 3 mm. This coextrusion is carried out at a temperature of 240° C. for each of the extruders used, and for the coextrusion head. The die is maintained at a temperature of 250° C. Peeling at t+24 hours (that is to say, 24 h after extrusion) gives an adhesive strength of 60 N/cm. The structure obtained does not exhibit any coextrusion defect; the internal surface is perfectly smooth, without any coextrusion corrugation.

### Example 2

### Comparative

The preparation is carried out, on an extruder of McNeil type, of a three layer structure composed, from the inside outwards, of a layer with a thickness of 300 μm of a blend of 30% of PVDF-1 and of 70% of Kynar® 720, coextruded over a layer with a thickness of 100 μm of Lotader® 8840. This layer is itself coextruded over a layer with a thickness of 2.6 mm of Finathene® 3802. The final structure exhibits an external diameter of 32 mm and a thickness of 3 mm. This coextrusion is carried out at a temperature of 240° C. for each of the extruders used, and for the coextrusion head. The die is maintained at a temperature of 250° C. Peeling at t+24 hours give an adhesive strength of 50 N/cm. The internal surface exhibits slight coextrusion corrugations.

### Example 3

### Comparative

The preparation is carried out, on an extruder of McNeil type, of a three layer structure composed, from the inside outwards, of a layer with a thickness of 300 μm of Fortron® 0214, coextruded over a layer with a thickness of 100 μm of Lotader® 8840. This layer is itself coextruded over a layer with a thickness of 2.6 mm of Finathene® 3802. The final structure exhibits an external diameter of 32 mm and a thickness of 3 mm. This coextrusion is carried out
at a temperature of 315° C. for the PPS extruder and 240° C. for the other materials, and for the coextrusion head. The die is maintained at a temperature of 315° C. Peeling at t+24 hours give an adhesive strength of 40 N/cm. The internal surface exhibits slight coextrusion corrugations.

### Example 4

### According to the Invention

The preparation is carried out, on an extruder of McNeil type, of a three layer structure composed, from the inside outwards, of a layer with a thickness of 300 μm of Fortron® 0214, coextruded over a layer with a thickness of 100 μm of a blend obtained by dry blending, at the foot of the machine, 50% by weight of Lotader® 8840 and 50% of Finathene® 3802 HDPE. This layer is itself coextruded over a layer with a thickness of 2.6 mm of Finathene® 3802. The final structure exhibits an external diameter of 32 mm and a thickness of 3 mm. This coextrusion is carried out at a temperature of 315° C. for the PPS extruder and 240° C. for the other materials, and for the coextrusion head. The die is maintained at a temperature of 315° C. Peeling at t+24 hours gives an adhesive strength of 45 N/cm. The structure obtained exhibits a few gel particles but no coextrusion defect; the internal surface is perfectly smooth, without any corrugation.

### Example 5

### According to the Invention

The preparation is carried out, on an extruder of McNeil type, of a three layer structure composed, from the inside outwards, of a layer with a thickness of 300 μm of a blend of 30% of PVDF-1 and of 70% of Kynar® 720, coextruded over a layer with a thickness of 100 μm of a blend obtained by dry blending, at the foot of the machine, 30% by weight of Lotader® 8840 and 70% of Finathene® 3802 HDPE. This layer is itself coextruded over a layer with a thickness of 2.6 mm of Finathene® 3802. The final structure exhibits an external diameter of 32 mm and a thickness of 3 mm. This coextrusion is carried out at a temperature of 240° C. for each of the extruders used, and for the coextrusion head. The die is maintained at a temperature of 250° C. Peeling at t+24 hours gives an adhesive strength of 65 N/cm. The structure obtained does not exhibit any coextrusion defect; the internal surface is perfectly smooth, without any coextrusion corrugation.

### Example 6

### According to the Invention

The preparation is carried out, on an extruder of McNeil type, of a three layer structure composed, from the inside outwards, of a layer with a thickness of 300 μm of a blend of 30% of PVDF-1 and of 70% of Kynar® 720, coextruded over a layer with a thickness of 100 μm of a blend obtained by dry blending, at the foot of the machine, 15% by weight of Lotader® 8840 and 85% of Finathene® 3802 HDPE. This layer is itself coextruded over a layer with a thickness of 2.6 mm of Finathene® 3802. The final structure exhibits an external diameter of 32 mm and a thickness of 3 mm. This coextrusion is carried out at a temperature of 240° C. for each of the extruders used, and for the coextrusion head. The die is maintained at a temperature of 250° C. Peeling at t+24 hours gives an adhesive strength of 70 N/cm. The structure obtained does not exhibit any coextrusion defect; the internal surface is perfectly smooth, without any coextrusion corrugation.

What is claimed is:

1. A structure successively comprising:
a layer of barrier polymer,
a tie layer comprising, the total being 100%:
1 to 80% of at least one polyethylene having epoxy functional groups,
99 to 20% of at least one viscous polymer compatible with the polyethylene having epoxy functional groups,
a polyethylene layer,
wherein the layers adhere in their respective contact zones.

2. The structure of claim 1 further comprising and adhering successively to the polyethylene layer to form a five-layer structure:
a tie layer comprising, the total being 100%:
1 to 80% of at least one polyethylene having epoxy functional groups,
99 to 20% of at least one viscous polymer compatible with the polyethylene having epoxy functional groups,
a layer of barrier polymer,
wherein the layers adhere in their respective contact zones.

3. The structure according to claim 1, wherein the viscous polymer compatible with the polyethylene having epoxy functional groups is chosen from hydrogenated SBS block copolymers, EPRs, EPDMs and polyethylene.

4. The structure according to claim 3, wherein the viscous polymer compatible with the polyethylene having epoxy functional groups is polyethylene.

5. The structure according to claim 1, wherein the viscous polymer compatible with the polyethylene having epoxy functional groups is high density polyethylene (HDPE).

6. The structure according to claim 1, wherein the MFI of the viscous polymer compatible with the polyethylene having epoxy functional groups is between 0.1 and 1 g/10 min at 190° C. and under 2.16 kg.

7. The structure according to claim 6, wherein the MFI of the viscous polymer compatible with the polyethylene having epoxy functional groups is between 0.15 and 0.5 g/10 min at 190° C. and under 2.16 kg.

8. The structure according to claim 1, wherein, the polyethylene having epoxy functional groups is a copolymer of ethylene and of an unsaturated epoxide.

9. The structure according to claim 1, wherein the proportions of the tie layer are:
10 to 50% of the polyethylene having epoxy functional groups,
90 to 50% of the viscous polymer compatible with the polyethylene having epoxy functional groups.

10. The structure according to claim 9, wherein the proportions of the tie layer are:
10 to 40% of the polyethylene having epoxy functional groups,
90 to 60% of the viscous polymer compatible with the polyethylene having epoxy functional groups.

11. The structure according to claim 1, wherein the Melt Flow Index (MFI) of the tie layer is between 0.15 and 1 g/10 minutes (measured at 190° C. under 2.16 kg).

12. The structure according to claim 1, wherein the layer of barrier polymer comprises, the total being 100%, from 1 to 100% of functionalized barrier polymer and 99 to 0% of barrier polymer.

13. The structure according to claim 12, wherein the layer of barrier polymer comprises, the total being 100%, from 1 to 40% of functionalized barrier polymer and 99 to 60% of barrier polymer.

14. The structure according to claim 13, wherein the layer of barrier polymer comprises, the total being 100%, from 15 to 40% of functionalized barrier polymer and 85 to 60% of barrier polymer.

15. The structure according to claim 1, wherein the layer of barrier polymer is composed of two layers, one comprising a blend, the total being 100%, of 1 to 100% of functionalized barrier polymer and 99 to 0% of barrier polymer, this layer being positioned against the tie layer, and the other composed of the barrier polymer.

16. The structure according to claim 15, wherein the layer of barrier polymer is composed of two layers, one comprising a blend, the total being 100%, of 1 to 40% of functionalized barrier polymer and 99 to 60% of barrier polymer, this layer being positioned against the tie layer, and the other composed of the barrier polymer.

17. The structure according to claim 16, wherein the layer of barrier polymer is composed of two layers, one comprising a blend, the total being 100%, of 15 to 40% of functionalized barrier polymer and 85 to 60% of barrier polymer, this layer being positioned against the tie layer, and the other composed of the barrier polymer.

18. The structure according to claim 1, in which the barrier polymer is PVDF.

19. The structure according to claim 1 comprising a device for the storage or transfer of fluids, in which the layer of barrier polymer is in contact with the stored or transported fluid.

20. A structure successively comprising:
a layer of barrier polymer,
a tie layer comprising, the total being 100%:
1 to 80% of at least one polyethylene carrying epoxy functional groups,
99 to 20% of at least one viscous polyethylene compatible with the polyethylene carrying epoxy functional groups,
wherein the layers adhere in their respective contact zones.

21. The structure of claim 20 further comprising a second layer of barrier polymer on the opposite side of the tie layer as the first barrier layer, resulting in a structure comprising:
a layer of barrier polymer,
a tie layer comprising, the total being 100%:
1 to 80% of at least one polyethylene carrying epoxy functional groups,
99 to 20% of at least one viscous polyethylene compatible with the polyethylene carrying epoxy functional groups,
a layer of barrier polymer,
wherein the layers adhere in their respective contact zones.
